(19) United States
(12) Patent Application Publication
(10) Pub. No.: US 2016/0054645 A1
(43) Pub. Date: Feb. 25, 2016

(54) EXTERNAL CAMERA FOR A PORTABLE ELECTRONIC DEVICE

(71) Applicants: PAUL CONTINO, HUNTINGTON STATION, NY (US); FRANK REGANATO, MOUNT SINAI, NY (US)

(72) Inventors: PAUL CONTINO, HUNTINGTON STATION, NY (US); FRANK REGANATO, MOUNT SINAI, NY (US)

(21) Appl. No.: 14/831,149

(22) Filed: Aug. 20, 2015

Related U.S. Application Data
(60) Provisional application No. 62/040,009, filed on Aug. 21, 2014.
(60) Provisional application No. 62/162,015, filed on May 15, 2015.

(51) Int. Cl. G03B 17/56; H04W 84/12; H04N 7/18; H04N 5/232; H04N 5/235

(52) U.S. Cl. CPC G03B 17/561; H04N 5/23296; H04N 5/2353; H04N 7/183; H04W 84/12

(57) ABSTRACT

An external camera for a portable electronic device including: a first portion configured to connect to a person's finger, the first portion including a camera and a first terminal; a second portion configured to connect to a person's hand, the second portion including a second terminal for connecting with the first terminal of the first portion, and a first switch and a second switch for controlling the camera; and a wire connected between the first terminal of the first portion and the second terminal of the second portion.

### CROSS-REFERENCE TO RELATED APPLICATIONS

This application claims priority to U.S. Patent Application No. 62/040,009 filed Aug. 21, 2014 and U.S. Patent Application No. 62/162,015 filed May 15, 2015, the disclosures of which are incorporated by reference herein in their entireties.

### TECHNICAL FIELD

The present invention relates to accessories for portable electronic devices such as smartphones or tablets.

### DISCUSSION OF THE RELATED ART

Portable electronic devices include a variety of electronic devices such as a tablet, a laptop, a smartphone, an e-reader or an MP3 player. Many of these devices, particularly smartphones and tablets, include built-in cameras. However, because these cameras are restricted to the body of their portable electronic device, they are unable to take pictures where the device cannot go or where it is too cumbersome to use for photo taking. In addition, portable electronic devices are generally limited to the zoom ratio of their built-in camera.

### SUMMARY

In an exemplary embodiment of the present invention, there is provided an external camera for a portable electronic device comprising: a first portion configured to connect to a person's finger, the first portion including a camera and a first terminal; a second portion configured to connect to a person's hand, the second portion including a second terminal for connecting with the first terminal of the first portion, and a first switch and a second switch for controlling the camera; and a wire connected between the first terminal of the first portion and the second terminal of the second portion.

The second portion includes a radio frequency (RF) module, wherein image data captured by the camera is provided to the RF module via the wire.

The RF module transmits the image data to a portable electronic device.

The portable electronic device includes a smartphone or a tablet.

The RF module includes a WiFi module.

The first switch controls a zoom feature of the camera.

The second switch controls a shutter feature of the camera.

In an exemplary embodiment of the present invention, there is provided a system including an external camera and a portable electronic device comprising: a portable electronic device; and an external camera, the external camera including: a camera and light module, the camera and light module including a strap for connecting the camera and light module to a person's finger; and a control module, the control module including a strap for connecting the control module to a person's hand away from the person's finger, wherein the camera and light module is configured to obtain image data and provide the image data to the control module via a databus, wherein the control module is configured to control the camera and light module in obtaining the image data and wirelessly provide the image data to the portable electronic device in near real-time streaming format. The image data is provided from the control module to the portable electronic device via a WiFi link.

The image data is viewed on a display of the portable electronic device.

The portable electronic device includes a software application enabling the portable electronic device to display the image data received from the external camera.

A zoom ratio of the external camera is greater than that of a built-in camera of the portable electronic device.

The portable electronic device includes a smartphone or a tablet.

The control module includes buttons or switches to control a zoom feature of the camera and lighting module.

In an exemplary embodiment of the present invention, there is provided a method of operating an external camera for a smartphone comprising: activating the external camera, the external camera including: a first portion configured to connect to a person's finger, the first portion including a camera; and a second portion configured to connect to a person's hand, the second portion including at least one switch for controlling the camera; activating a software application on the smartphone, wherein in response to the activation of the software application a wireless link is established between the external camera and the smartphone; streaming live video from the external camera to the smartphone via the wireless link; displaying the live video on a the smartphone; and controlling the external camera based on the live video displayed on the smartphone.

Controlling the external camera includes moving the external camera, zooming in or out with the external camera, or capturing a still image with the external camera.

### BRIEF DESCRIPTION OF THE DRAWINGS

FIG. 1 illustrates an external camera for a portable electronic device according to an exemplary embodiment of the present invention;

FIG. 2 illustrates a block diagram showing an external camera for a portable electronic device connected to a smartphone in accordance with an exemplary embodiment of the preset invention;

FIG. 3 illustrates a system block diagram of an external camera for a portable electronic device according to an exemplary embodiment of the present invention;

FIG. 4 illustrates an external camera for a portable electronic device disposed on a person's hand according to an exemplary embodiment of the present invention;

FIG. 5A illustrates an external camera for a portable electronic device disposed on a person's hand according to an exemplary embodiment of the present invention;

FIG. 5B illustrates an external camera for a portable electronic device disposed on a person's hand according to an exemplary embodiment of the present invention;

FIG. 5C illustrates an external camera for a portable electronic device disposed on a person's hand according to an exemplary embodiment of the present invention;

FIG. 6 illustrates an external camera for a portable electronic device disposed on a person's hand according to exemplary embodiments of the present invention;

FIG. 7 illustrates an external camera for a portable electronic device disposed on a person's hand according to an exemplary embodiment of the present invention;

FIG. 8 illustrates an external camera for a portable electronic device being held in a person's hand according to an exemplary embodiment of the present invention;

FIG. 9A illustrates an external camera for a portable electronic device disposed on a person's hand according to an exemplary embodiment of the present invention;

FIG. 9B is another view of the external camera of FIG. 9A;

FIG. 10A illustrates an external camera for a portable electronic device disposed on a person's hand according to an exemplary embodiment of the present invention;

FIG. 10B is another view of the external camera of FIG. 10A;

FIG. 11A illustrates an external camera for a portable electronic device disposed on a person's hand according to an exemplary embodiment of the present invention;

FIG. 11B is another view of the external camera of FIG. 11A;

FIG. 12 illustrates a smartphone interface for an external camera for a portable electronic device according to an exemplary embodiment of the present invention;

FIG. 13 illustrates an application example of an external camera for a portable electronic device according to an exemplary embodiment of the present invention;

FIG. 14 illustrates an application example of an external camera for a portable electronic device according to an exemplary embodiment of the present invention;

FIG. 15 illustrates an application example of an external camera for a portable electronic device according to an exemplary embodiment of the present invention;

FIG. 16 illustrates an application example of an external camera for a portable electronic device according to an exemplary embodiment of the present invention;

FIG. 17 illustrates an application example of an external camera for a portable electronic device according to an exemplary embodiment of the present invention;

FIG. 18 illustrates an application example of an external camera for a portable electronic device according to an exemplary embodiment of the present invention; and

FIG. 19 illustrates a computer system in which an exemplary embodiment of the present invention may be implemented.

### DETAILED DESCRIPTION OF THE EMBODIMENTS

The present invention disclosed herein provides an external camera for portable electronic devices including, but not limited to, smartphones and tablets. More particularly, the portable electronic device may include any device running an Apple or Android operating system. In fact, the portable electronic device may not be limited to a hand-held portable electronic device. For example, the external camera may be operable with a stationary electronic device such as a workstation personal computer.

In brief, the external camera described herein is configured to fit onto the hand or index finger with a strap such as a Velcro strap. The external camera, or micro-cam, sits on top of the finger and a light may sit underneath the finger. The external camera connects to the lighting port of the portable electronic device by way of a wire that runs from the finger to the device. In place of the wired connection, a wireless connection may be used. For example, the wireless connection may be implemented with a short range wireless technology such as Bluetooth, ZigBee or Infrared light. The operating system of the portable electronic device includes application software (e.g., an app) to allow the external camera incorporate a variety of features such as record, real-time, single short, transmit, etc. The external camera has a variety of applications in construction, medical (e.g., zoom-in and magnify), vanity, and others such as simply looking around a corner. The external camera for a portable electronic device will now be described with reference to exemplary embodiments thereof.

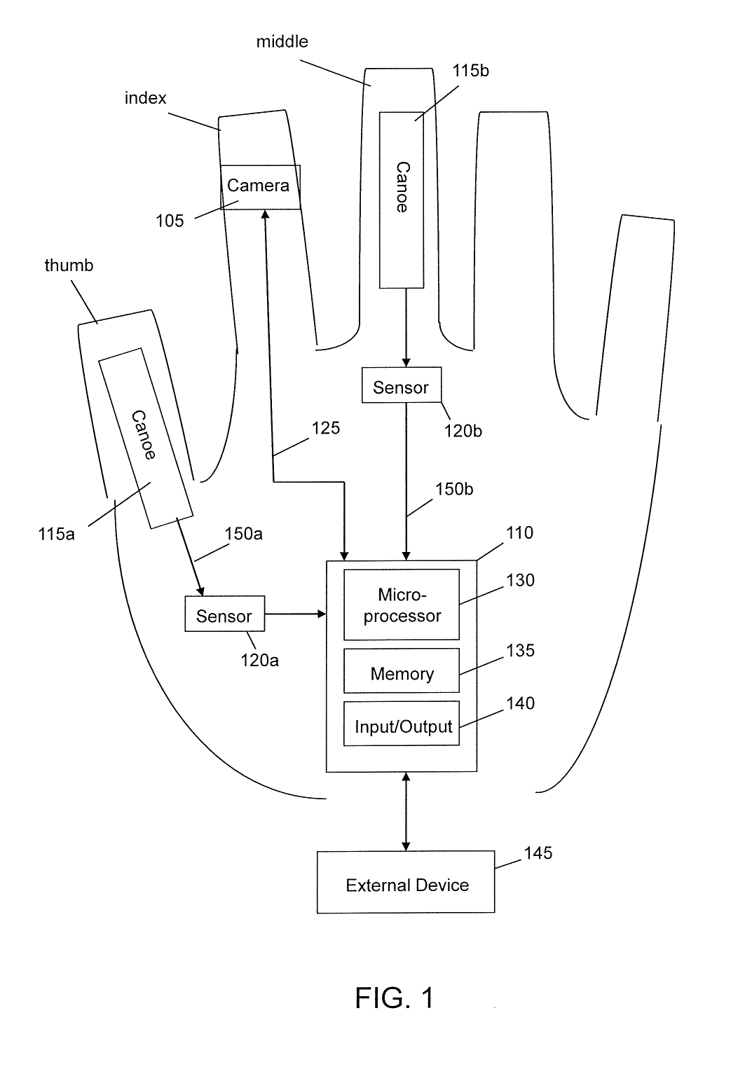

FIG. 1 is an external camera for a smartphone according to an exemplary embodiment of the present invention.

More particularly, FIG. 1 illustrates the components of the external camera. These components include, but are not limited to, a camera 105, a controller 110, canoes 115a and 115b, and sensors 120a and 120b.

Although not illustrated in FIG. 1, the components of the external camera are included in a sheath that may fit the hand of a person. The sheath may be made for the right hand or the left hand of a person. Further, the sheath may be made to cover all five fingers of a person or any number of fingers fewer than five. In the example shown in FIG. 1, the sheath is contemplated to cover three fingers (thumb, index, middle) of the right hand of a person as well as at least a portion of their palm.

Images captured by the camera 105 may be sent to the controller 110 via a databus 125. The camera 105 may capture still images as well as record video. The camera 105 may include its own light source or a light source may be further included in the external camera's sheath. In this case, the light source may be located on the same finger as the camera 105.

The controller 110 may include a microprocessor 130, a memory 135 and an input/output 140. The microprocessor 130 may control the camera 105 to operate in a video mode or a still image mode. The microprocessor 130 handles general processing operations of the external camera. The memory 135 may store image data from the camera 105. The input/output 140 may constitute a variety of devices.

For example, the input/output 140 may include a short-range wireless transceiver (e.g., Bluetooth) that permits the image data from the camera 105 to be wirelessly transmitted to an external device 145. The input/output 140 may also include a long-range wireless transceiver (e.g., Radio Frequency) permitting the image data from the camera 105 to be transmitted to non-local external devices or the internet. Further, the input/output 140 can be a wired interface (e.g., a Universal Serial Bus (USB) interface).

Although not shown in FIG. 1, the external camera may include its own power source such as an on-board battery that can be recharged via a physical port of the input/output 140 such as a USB interface, or via a wireless charger. The external camera may also be powered by connection to the external device 145 through, for example, a physical port of the input/output 140 such as a USB interface.

The canoes 115a and 115b may be conformally shaped with the bottom part or top part of the finger on which they are used. The canoes 115a and 115b may be made of plastic and embedded in the sheath. It is to be understood, however, that the canoes 115a and 115b are not limited by the aforementioned shapes (e.g., they can be rectangular) or by the aforementioned material (e.g., they can be made of metal). The canoes 115a and 115b are connected to the sensors 120a and 120b via respective connectors 150a and 150b. The connectors 150a and 150b may each be a flexible wire or cable, for example. Further, the canoes 115a and 115b may be electro-mechanical devices responsive to finger movement.

Further, the canoes 115a and 115b and sensors 120a and 120b may be integrally formed as a single device.

The sensors 120a and 120b are responsive to movement of the connectors 150a and 150b initiated by the canoes 115a and 115b. The sensors 120a and 120b provide data to the controller 110 indicative of the movement of the connectors 115a and 115b. The sensors 120a and 120b may each have a part that measures how far its connector has moved and a part that generates a digital signal indicative of the distance the connector has moved. For example, the sensors 120a and 120b may be electro-mechanical devices.

The canoes 115a and 115b and sensors 120a and 120b may operate to control zoom-in and zoom-out functions of the camera 105. For example, when the wearer of a sheath embodying the external camera moves their thumb downward, the connector 150a connected to the canoe 115a may move. The distance by which the connector 150a is moved is determined by the sensor 120a and the sensor 120a sends a corresponding signal to the microprocessor 130 to cause the camera 105 to zoom-in. The amount of zoom may correspond to the amount of movement. In other words, a little movement will result in a slight zoom and a lot of movement will result in more zoom. When the user moves their thumb back to its original position, the camera 105 will return to its original position. The processing related to the zoom control is handled by the microprocessor 130.

To accomplish the aforementioned zoom control, only one canoe-sensor pair may be needed. However, with a second canoe-sensor pair like that shown in FIG. 1, the second canoe-sensor pair can be used to control the angle of the camera 105. For example, when the wearer of the sheath embodying the external camera moves their middle finger up, a hinge on which the camera 105 is mounted may be moved to rotate the camera 105 upwards. If the user moves the middle finger down, the hinge may rotate the camera 105 downwards. Such capability may be needed, when the viewing angle of the camera 105 is not ideal.

It is to be understood that although two canoe-sensor pairs are shown in FIG. 1, only one canoe-sensor pair may be included in the sheath embodying the external camera. In this case, the sheath may only fit on two fingers. However, the sheath could still be designed to fit on more than two fingers for stability purposes. Further, although the components of the external camera have been described as being included in a sheath, the sheath is non-limiting. For example, some or all of the components may be secured to the user's hand by other means such as Velcro straps, individual finger sleeves and the like.

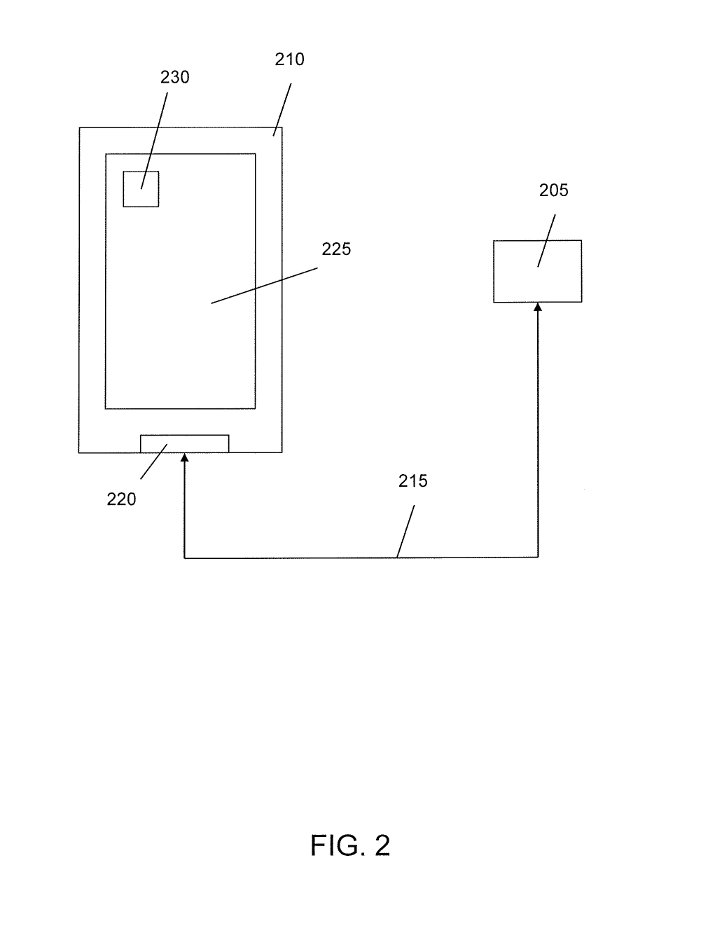

FIG. 2 is a block diagram showing the external camera for a smartphone of FIG. 1 connected to a smartphone.

More specifically, FIG. 2 shows an external camera 205, which may include the same components as the external camera shown in FIG. 1, connected to a smartphone 210 via a wired or wireless connection 215.

The smartphone 210 may be any of a number of smartphones such as an iPhone or Android phone, for example. The smartphone 210 is built on a mobile operating system such as iOS or Android, for example. It is to be understood that although the external camera is being described as an accessory for a smartphone, the external camera can work equally well with a tablet such as an iPad or Android tablet, for example.

The smartphone 210 may include its own input/output 220. The input/output 220 may include a USB interface, a short-range wireless transceiver (e.g., Bluetooth) or a long-range wireless transceiver (e.g., Radio Frequency). In other words, the connection 215 may a USB cable or a wireless link between the smartphone 210 and the external camera 205. The smartphone 210 may also include a display screen 225 for displaying images.

On the display screen 225, there may be shown a camera app 230 which is a software application that can be activated by touching a corresponding icon on the display screen 225. The camera app 230 may also be activated with a voice command. When the camera app 230 is activated, the display screen 225 may show a current image seen by the camera 105 (of FIG. 1).

An application example of the present invention will now be described.

For example, when a person wishes to observe a hard to reach or see space such as the space over a drop ceiling, a crawl space, the inside of a ventilation system or behind a wall (through a small hole or around a corner), the person may put on the external camera 205. The person may activate the external camera 205, as well as the camera app 230 on the smartphone 210. The person may then stick their finger with the camera 105 (of FIG. 1) into the space they want to see. The images taken by the camera 105 (of FIG. 1) are then fed to the smartphone 210 in real-time. Zoom-in and zoom-out control as well as camera viewing angle control may be effectuated by finger motion in the way described above.

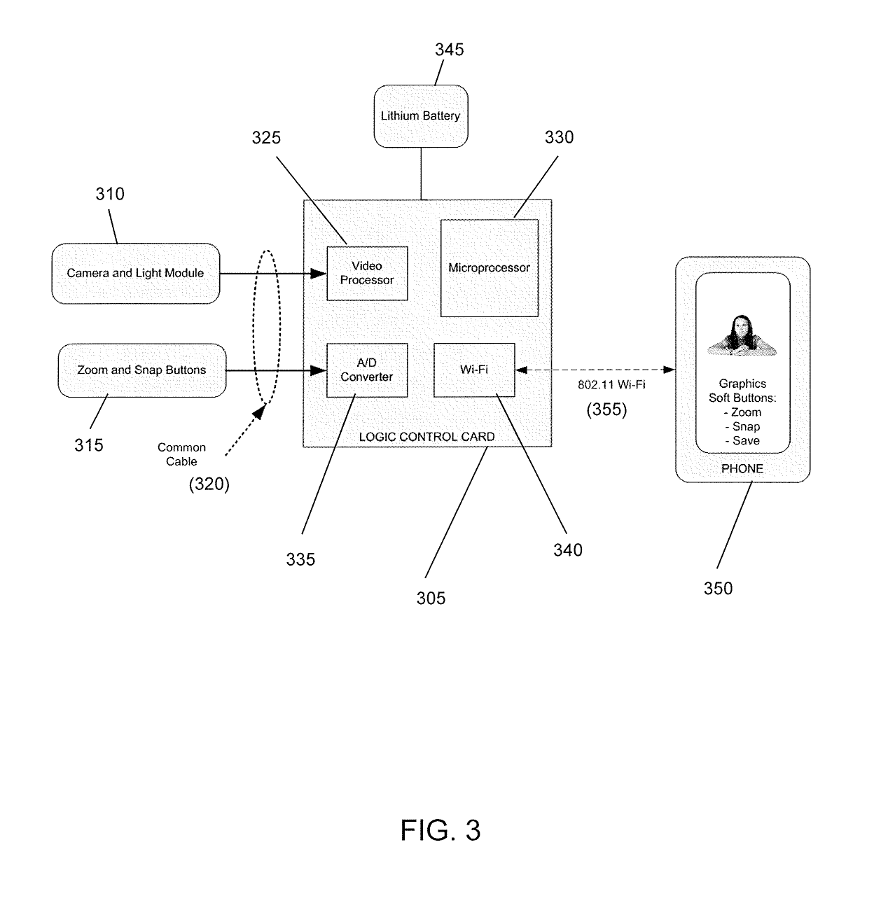

FIG. 3 illustrates a system block diagram of an external camera for a portable electronic device according to an exemplary embodiment of the present invention.

As shown in FIG. 3, the external camera includes a logic control card 305, a camera and light module 310 and zoom and snap buttons 315. The logic control card 305 is connected to the camera and light module 310 and the zoom and snap buttons 315 with a common cable 320. The logic control card 305 includes a video processor 325, a microprocessor 330, an analog-to-digital converter 335 and a WiFi module 340. The logic control card 305 may be powered by a battery 345 such as a lithium battery. The logic control card 305 may communicate data with a smartphone 350 via a wireless link 355 such as an 802.11 WiFi link.

The logic control card 305, the camera and light module 310 and the zoom and snap buttons 315 of the external camera may be hand mounted. The zoom and snap buttons 315 may be used to control zoom and shutter of the camera in the camera and light module 310, for example. The battery 345 may be rechargeable or not and may have a battery life of at least two hours, for example. An example target range of the camera may be at 2 feet, a field of view of 8″×10″ and at 10 feet, a field of view of 39″×51″. It is to be understood that these ranges are merely exemplary and can be varied. The lighting element in the camera and light module 310 may be a light emitting diode (LED). However, a variety of different lighting elements may be used. The LED may be controlled by ambient lighting and/or camera's exposure level. It is to be further understood that the camera and light do not have to be included in one module as shown in FIG. 3. For example, the camera and light can be included separately.

The camera also has a feature that allows for 15:1 to 20:1 capability. Streaming video as this or other (e.g., higher or lower) zoom ratios is sent to the smartphone 350. An image viewed on this data stream can be captured at any of the aforementioned zoom ratios. Zoom ratios can be set by a user. The zoom ratios of 15:1 or 20:1 are greater than most zoom ratios of existing smartphones which use 3:1, for example. Accordingly, the zoom ability of the micro-cam is greater than that of most smartphones, for example.

The camera may include an 8 megapixel camera and be disposed on a PCB with a general-purposed input/output (GPIO) header and a USB 3.0 connector. The camera may also include an 8, 13, 16 or 20 megapixel ultra small and low-power camera module with high-speed autofocusing. The camera may include features such as high-quality and low-illumination photo-taking and hand-shaking correction functions. However, the camera is not limited thereto.

The video processor 325 may be used process signals (e.g., streaming video) provided from the camera and light module 310. The analog-to-digital converter 335 may be used to convert analog signals received from the zoom and snap buttons 315 into digital form for use by the microprocessor 330. The microprocessor 330 may accept data as input from the video processor 325 and the analog-to-digital converter 335 and process the data according to instructions in its memory. Results of this processing may be provided as output via the WiFi link 355 to the smartphone 350. Wireless transmission of the video data over WiFi link 355 may occur at data rates ranging from 50-500 Mbps, for example.

Data rates may depend on the resolution of the video. The smartphone 350 may view the output provided over the link 355. The output may include still images taken by the camera or streaming video, for example.

The external camera may employ a variety of functional features. For example, the LED light can be used to illuminate a subject. Further, the LED light can be controlled by ambient lighting and the camera's current exposure level. In a photo mode, pressing the shutter can pulse the LED to provide a flash. In a video mode, the LED can be activated after pressing the shutter button.

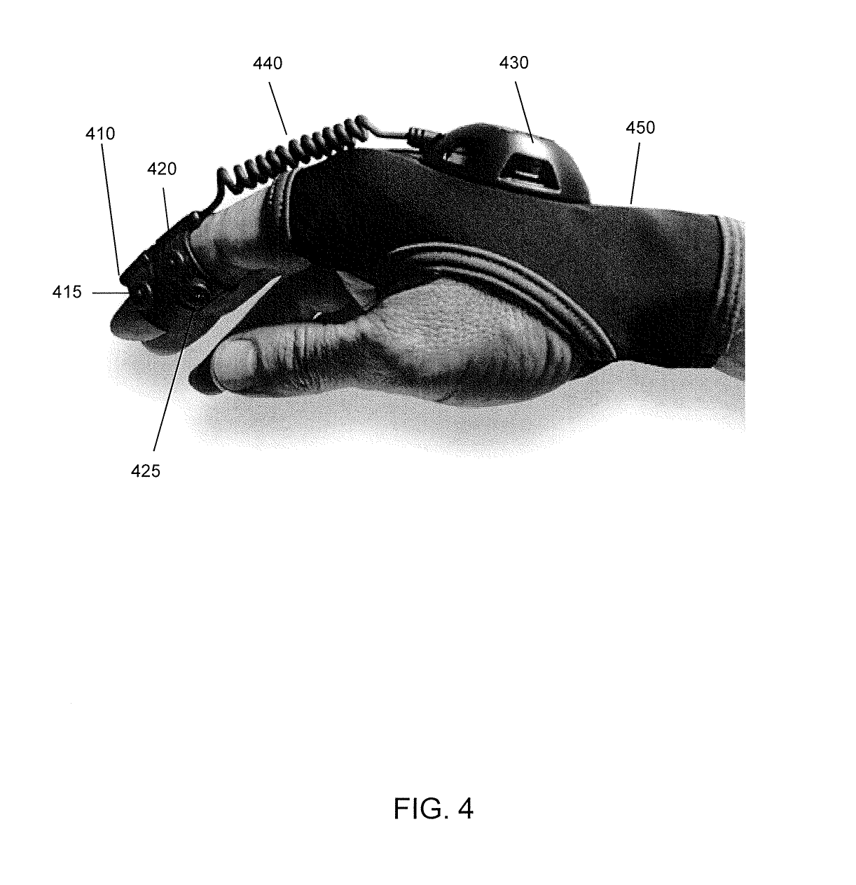

The external camera may be used for zoom and capture. For example, with reference to FIG. 4, camera 410 may be hand controlled via two buttons 415 and 420 in the vicinity of a user's thumb. The two buttons 415 and 420 control zoom in and zoom out functionality. An additional button 425 can be used to control a snap photo feature. As shown in FIG. 4, the buttons 415-425 may be disposed on an index finger strap.

FIG. 4 further shows an example of a case 430 for logic control card, a wire 440 connecting the camera 410 to the logic control card 430 and a sheath or glove 450 to which these components may be connected.

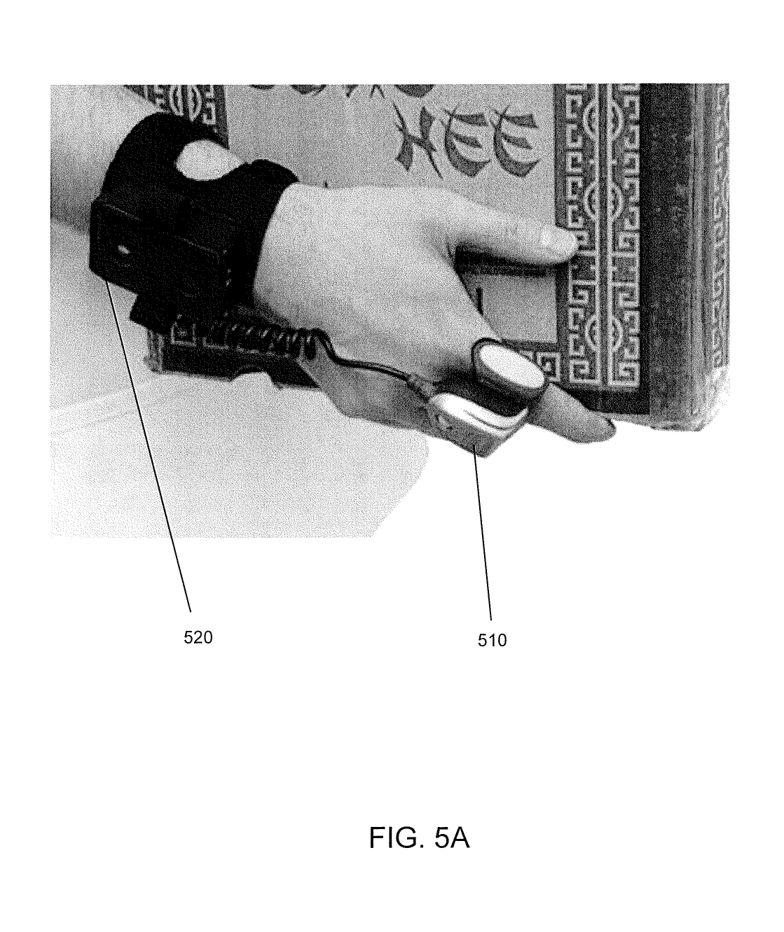

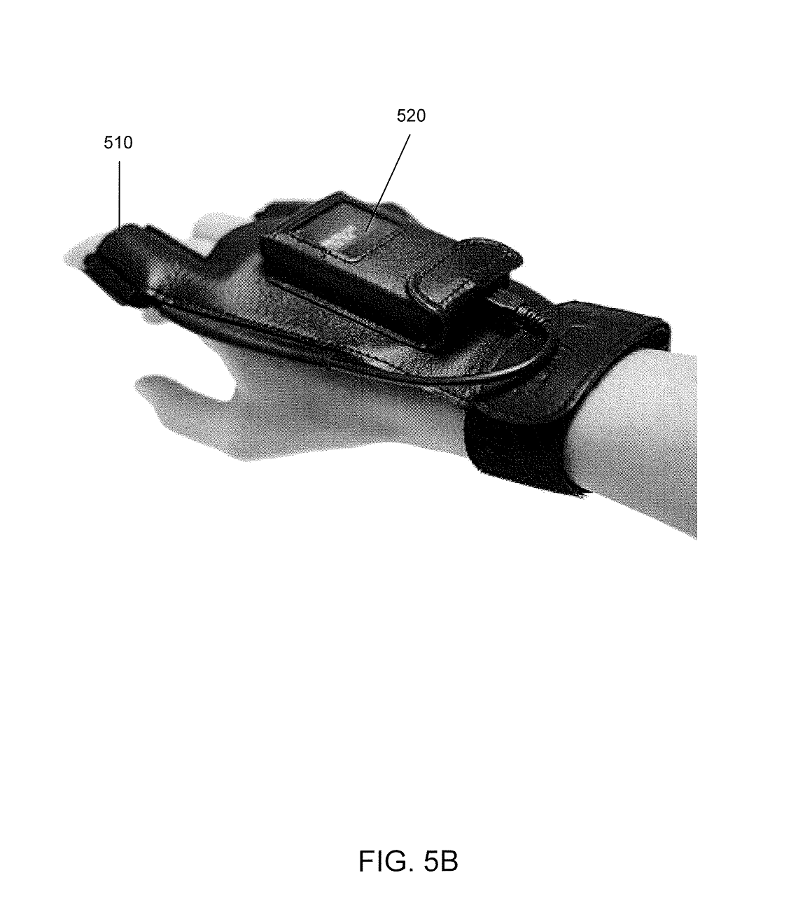

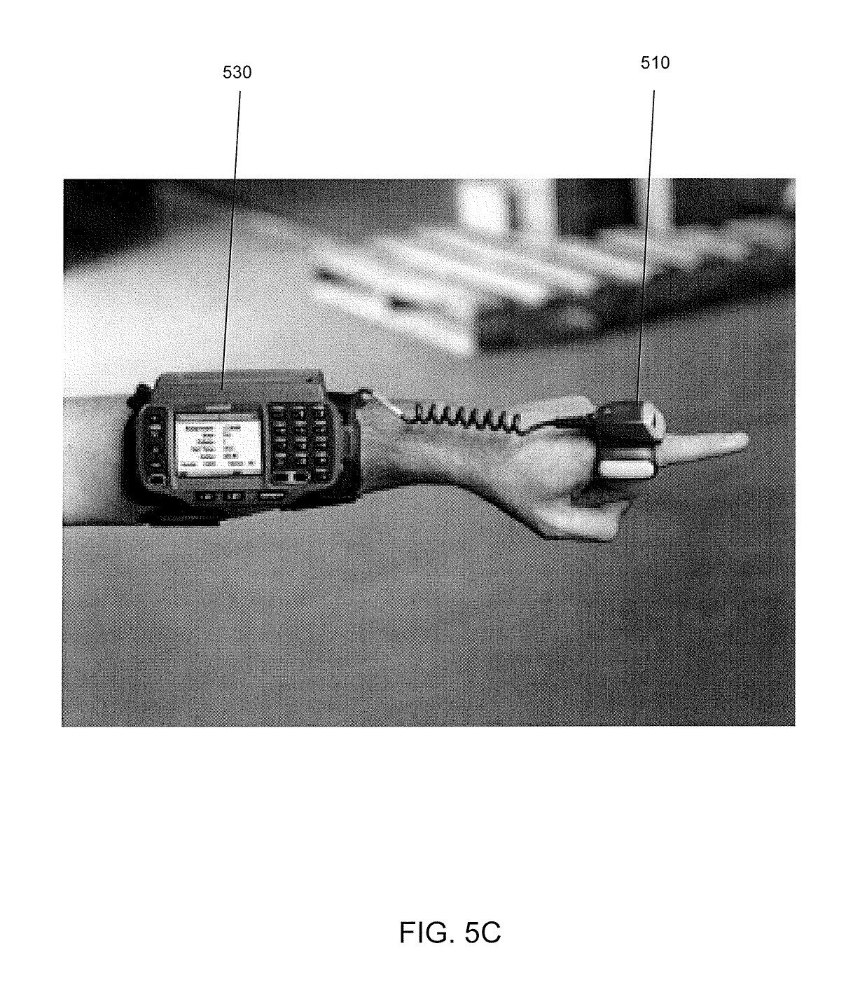

The external camera may have a variety of glove embodiments. For example, as shown in FIGS. 5A to 5C, the glove/camera combination may be designed for ambidextrous use and multiple hand sizes. The glove/camera combination may be flexible enough so that a user can maneuver their hand while using the camera. Further, the glove/camera combination is designed to support all the electronics and camera securely. In each of FIGS. 5A to 5C, camera 510 is provided on a user's finger and battery and processing 520 are provided on a user's wrist. As shown in FIG. 5C, battery and processing functions can be provided in a portable electronic device 530 linked to the camera 510 and strapped to the glove.

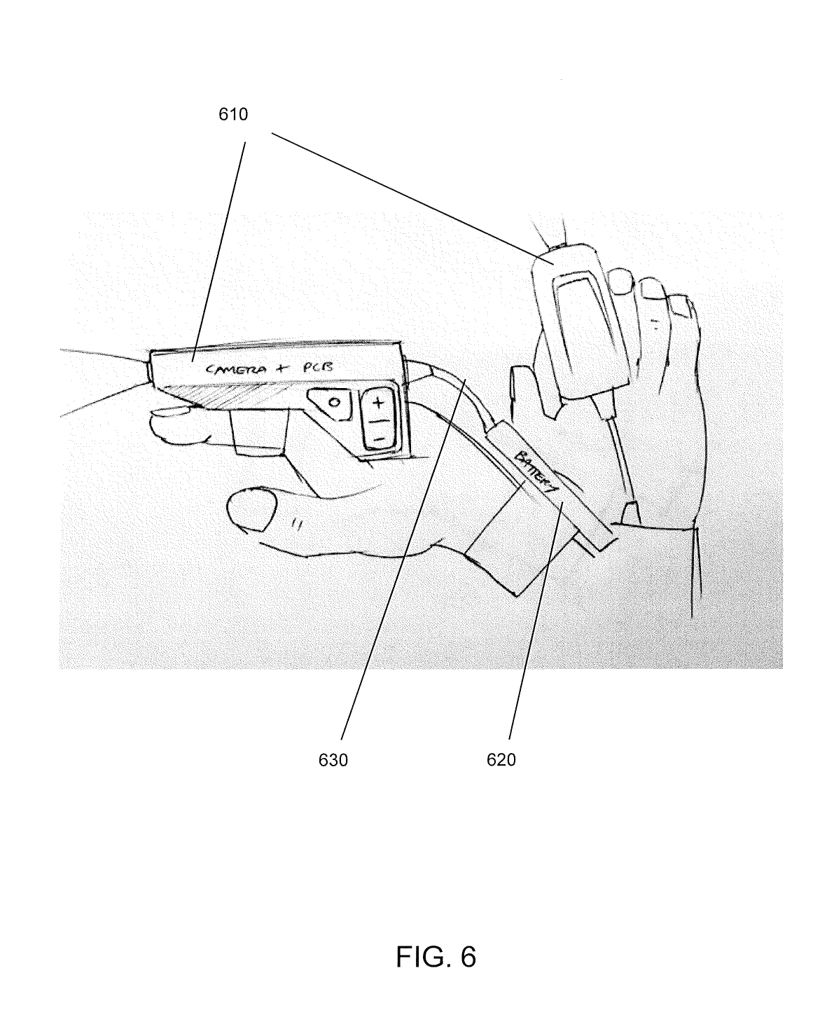

FIG. 6 shows an example of the external camera of the present invention in which there is provided a one or two finger design. A two finger design can be used in the case of a banana pi board. A one finger design can be used in other cases such as when a custom board is developed. As shown in FIG. 6, the length of a cable 630 from camera/PCB 610 to battery 620 is short.

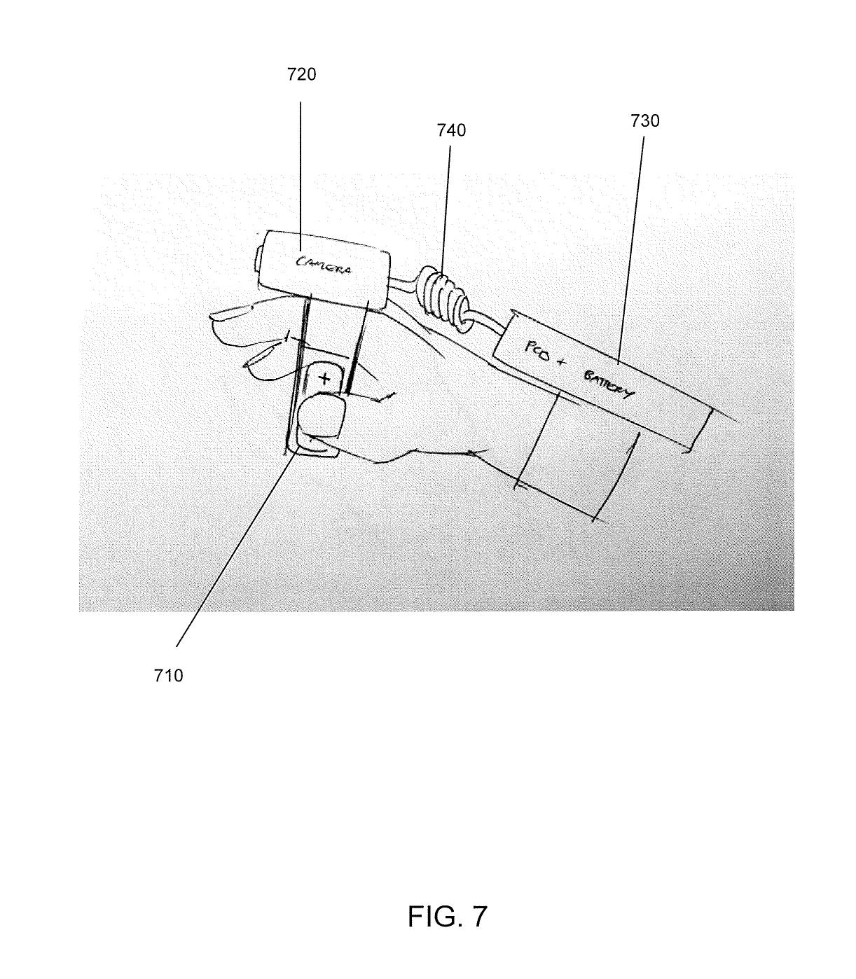

FIG. 7 shows an example of the external camera of the present invention in which rigid control buttons 710 drop from camera housing 720. In this case, PCB and battery 730 are mounted on a user's wrist by an adjustable strap. As shown in FIG. 7, the camera to PCB cable 740 may be increased in size as needed.

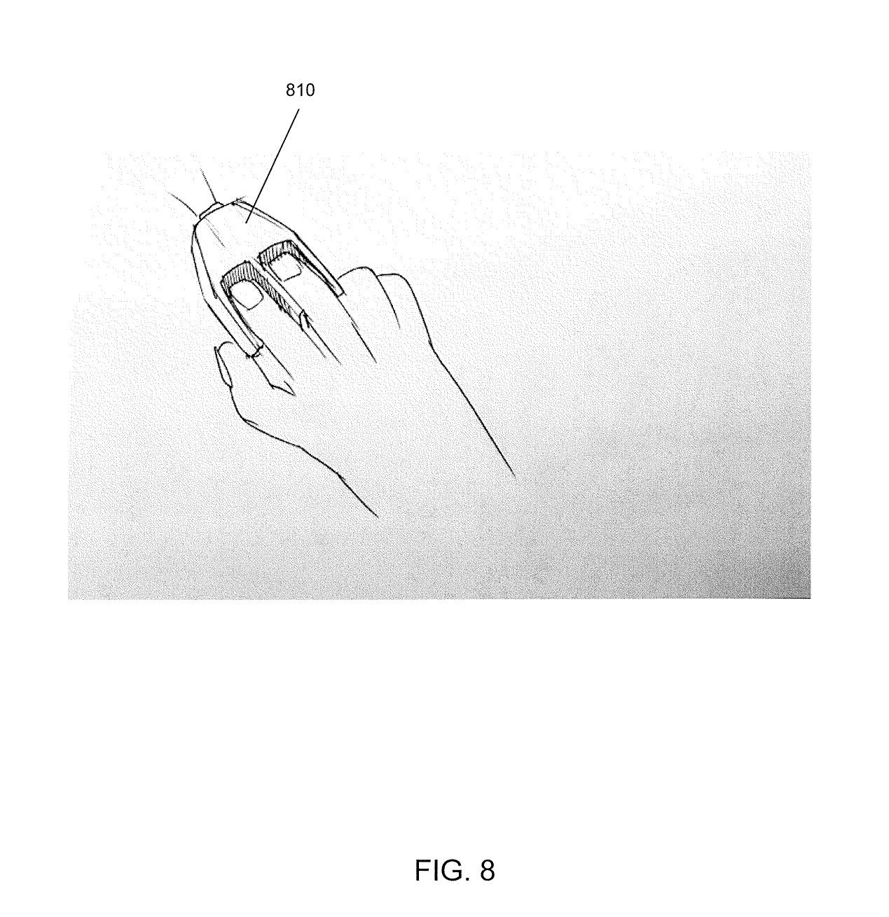

FIG. 8 shows an example of the external camera of the present invention in which a battery, camera and PCB are found in one unit 810. In this case, the camera is controlled by the thumb and held in place by the index and middle fingers. The camera protrudes forward of the finger tips.

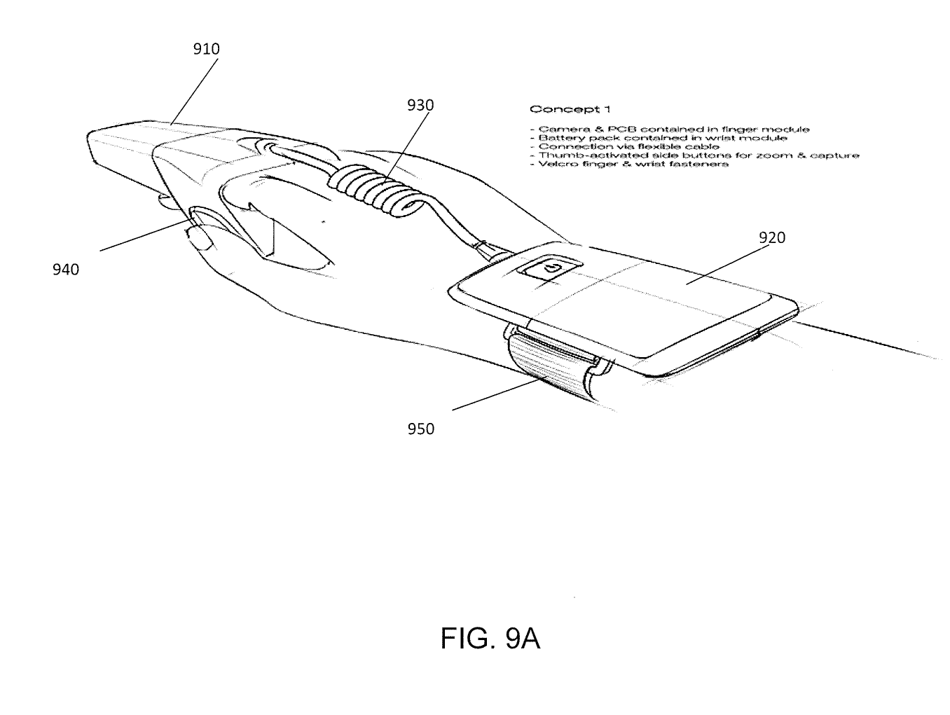

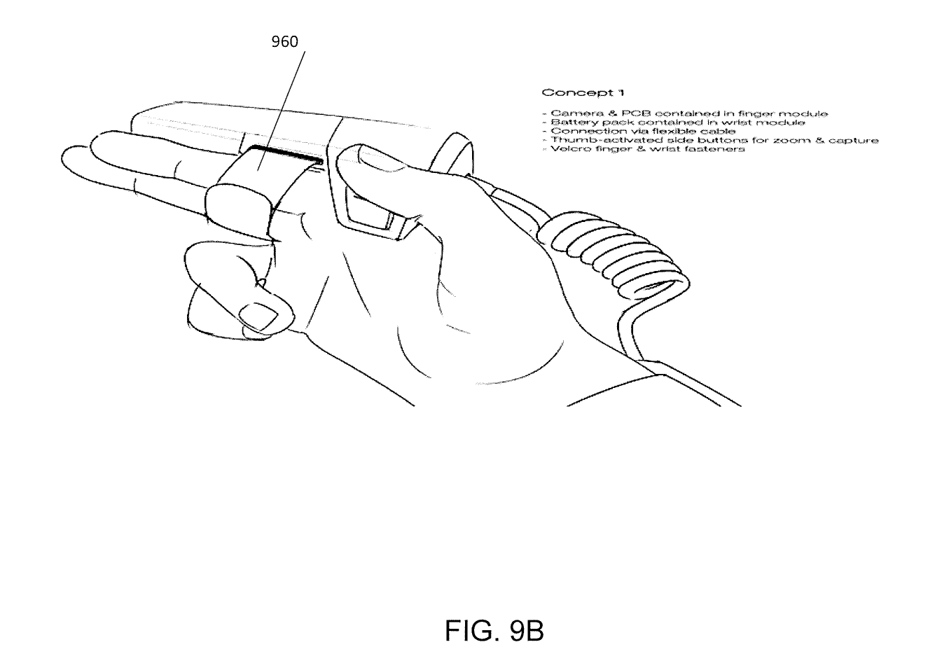

FIG. 9A shows an example of the external camera of the present invention in which a camera and PCB are contained in a finger module 910, a battery pack is contained in a wrist module 920 and the modules 910 and 920 are connected via a flexible cable 930. FIG. 9A also shows side activation buttons 940 for zoom and capture as well as a Velcro wrist fastener 950. FIG. 9B shows a Velcro finger fastener 960.

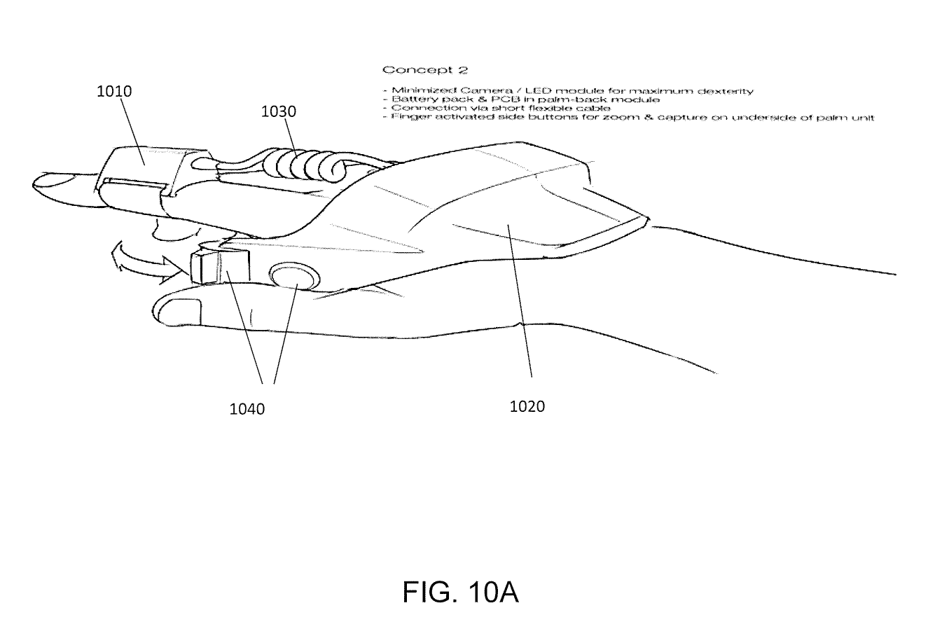

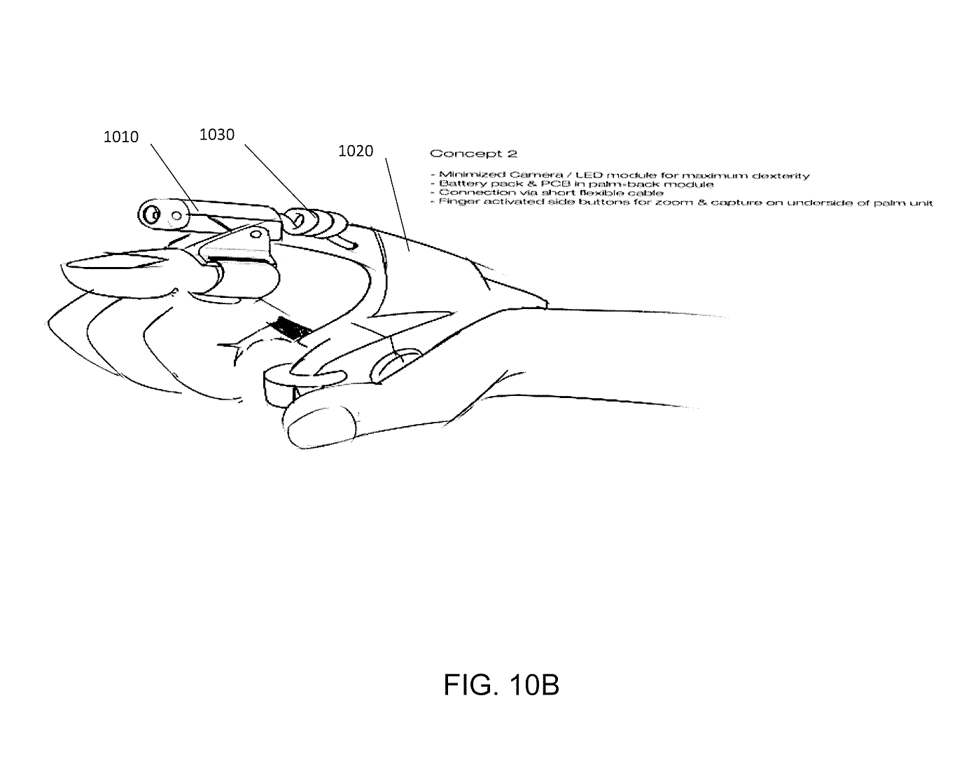

FIGS. 10A and 10B show an example of the external camera of the present invention in which there is provided a minimized camera/LED module 1010 for maximum dexterity, a battery pack and PCB in a plam-back module 1020, a connection via a short flexible cable 1030 and finger activated side buttons 1040 for zoom (left) and capture (right) on the underside of the palm unit.

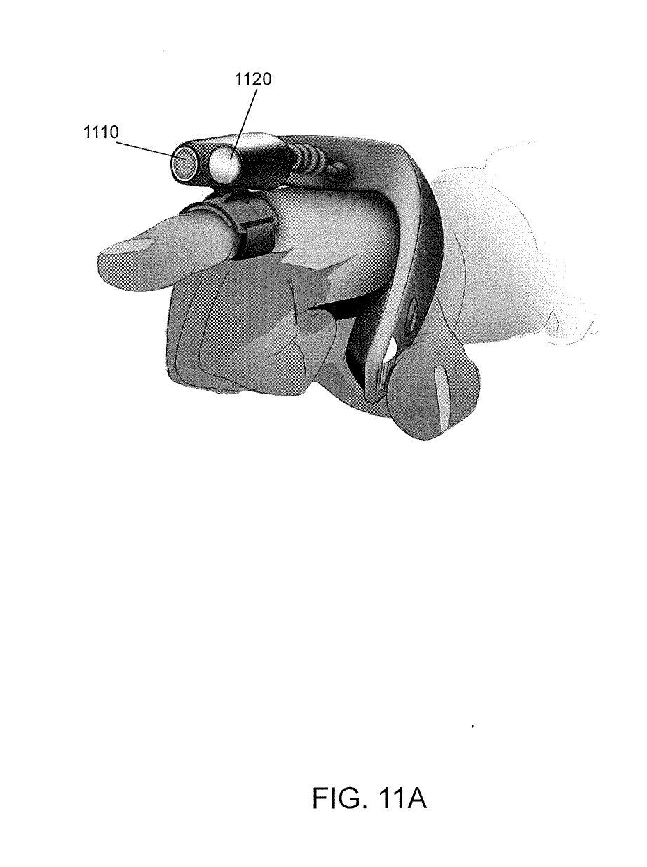

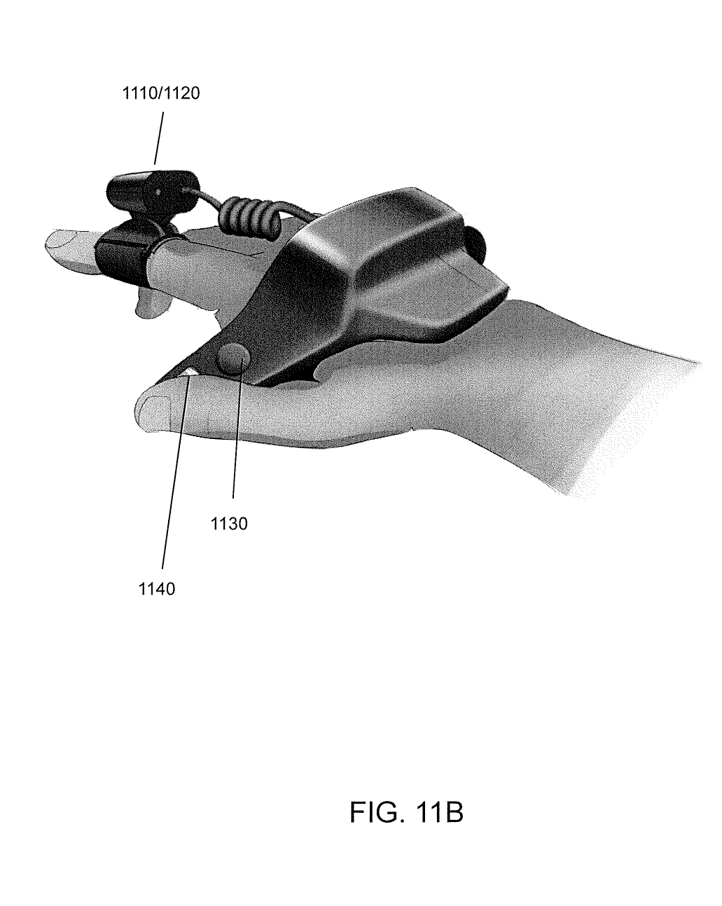

FIGS. 11A and 11B show an example of the external camera of the present invention in which a camera 1110 and a light 1120 are shown side-by-side. As an example, button 1130 may be a shutter button, while switch 1140 may be used for zooming features.

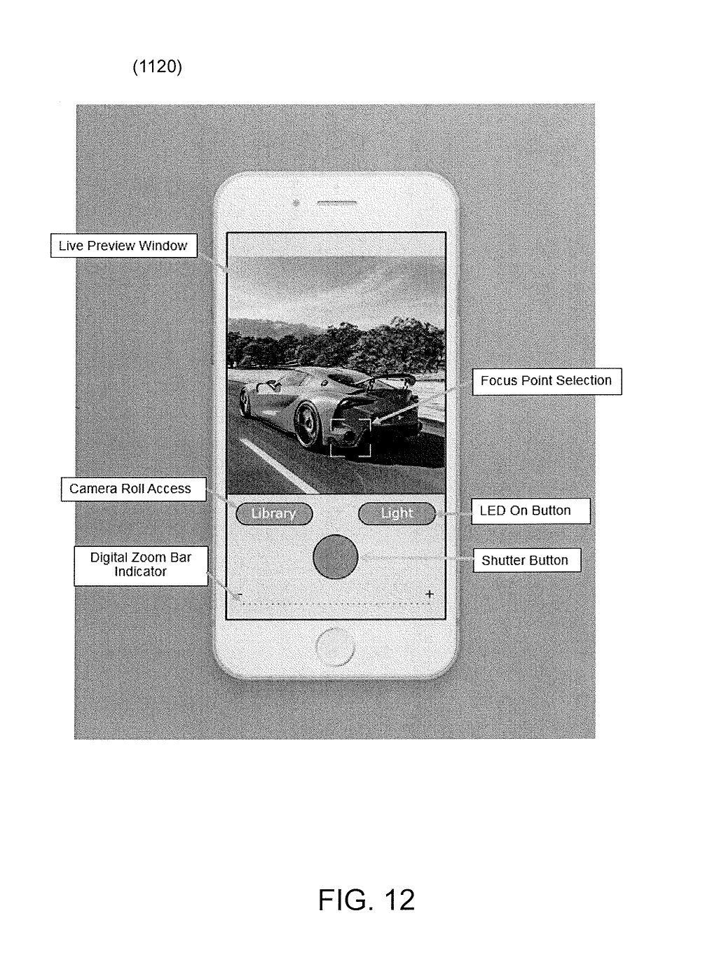

FIG. 12 illustrates a smartphone interface 1200 for an external camera for a portable electronic device according to an exemplary embodiment of the present invention. In this case, using an app that enables a smartphone to work with the external camera of the present invention, a variety of functionality can be provided.

For example, using the app, a connection can be established via peer-to-peer (P2P) WiFi with the external camera. In other words, the phone and external camera form a wireless link with each other. Through this link live video from the external camera can be streamed to the app for user preview. While viewing the live video, shutter control to record video or take a picture can be done with a hand button or switch on the external camera. Photos and videos from the external camera can be stored on the phone and viewed on the phone by contacting the ‘library’ button (see FIG. 12) in the app. The phone can send photos and videos from the external camera via email or instant messaging, for example. The external camera's focus point may be controlled by tapping on the screen of the phone (see ‘focus point selection’ in FIG. 12). The external camera's LED light can be controlled via a ‘light’ button (see FIG. 12) to be turned on or off, for example. The external camera may also include button for turning on and off its light. The external camera may have a sensor to determine whether flash is needed. The shutter button (FIG. 12) may be used by a user of the smartphone to store the image currently displayed on the smartphone. An image captured by the camera and shown on the smartphone may also be digitally zoomed.

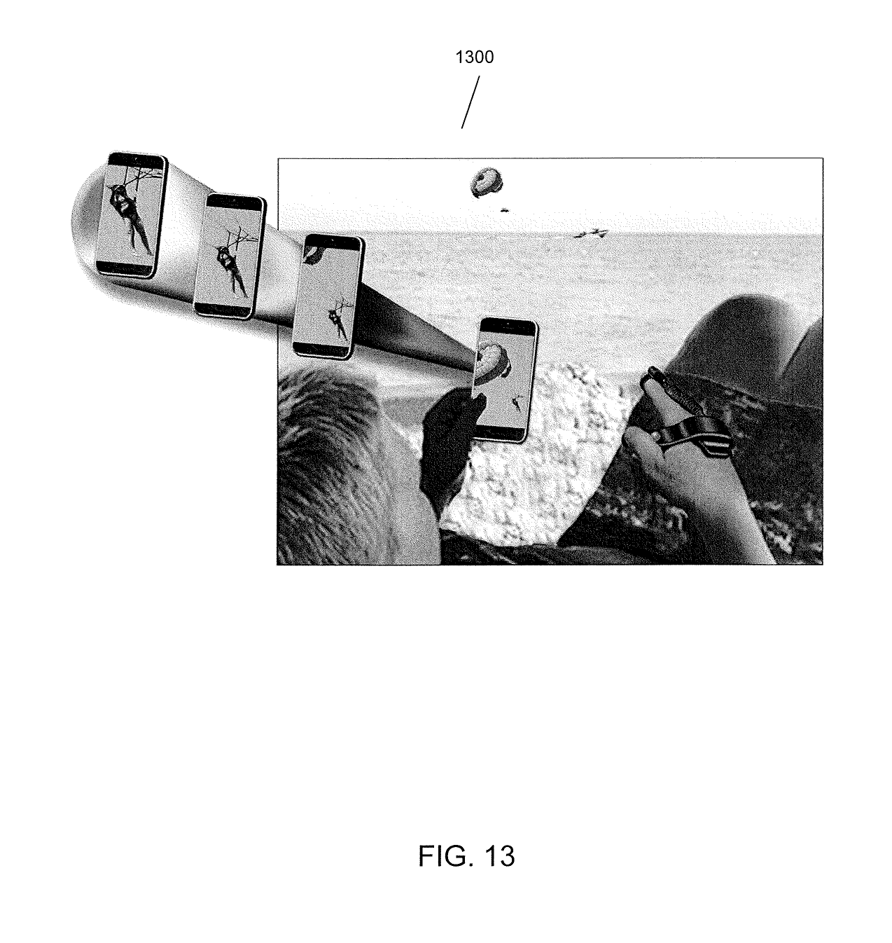

FIGS. 13 to 18 show a variety of application examples of the external camera of the present invention.

FIG. 13 shows an example 1300 in which the external camera is used to capture multiple zoomed images which are then sent to the smartphone and viewed.

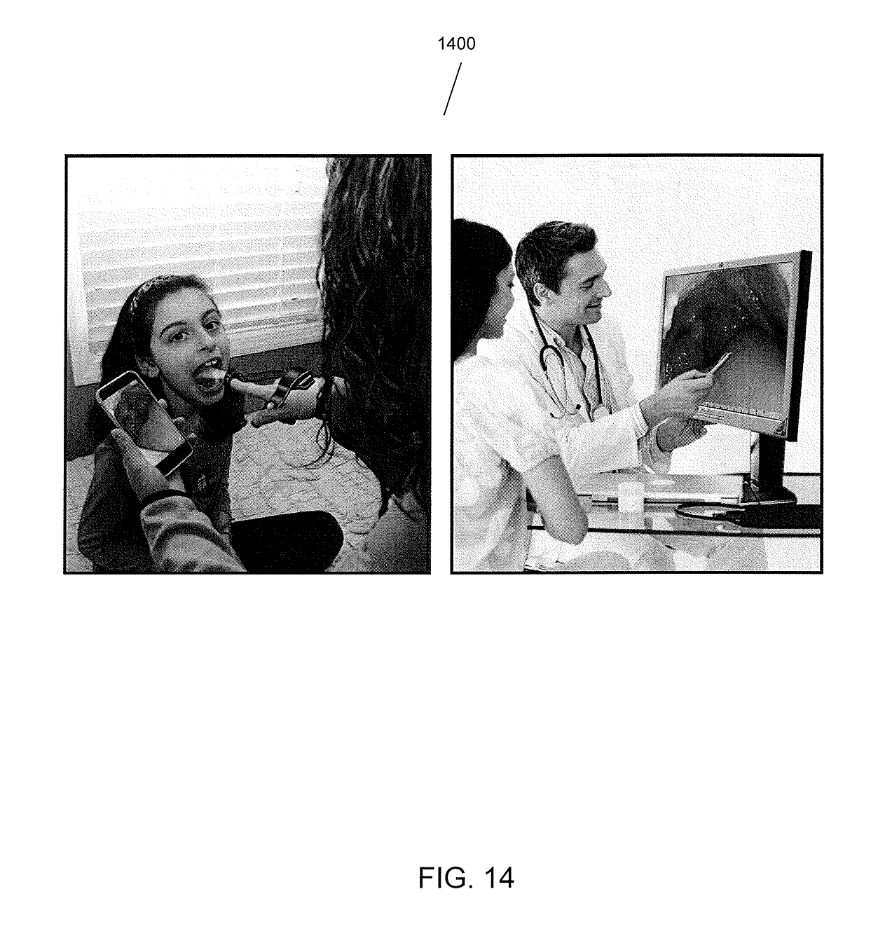

FIG. 14 shows an example 1400 in which the external camera is used in a medical environment. On the left side of FIG. 14, a medical professional uses the external camera to capture an image inside a patient's mouth. On the right side of FIG. 14, a medical professional views the images that were captured with the external camera on a computer.

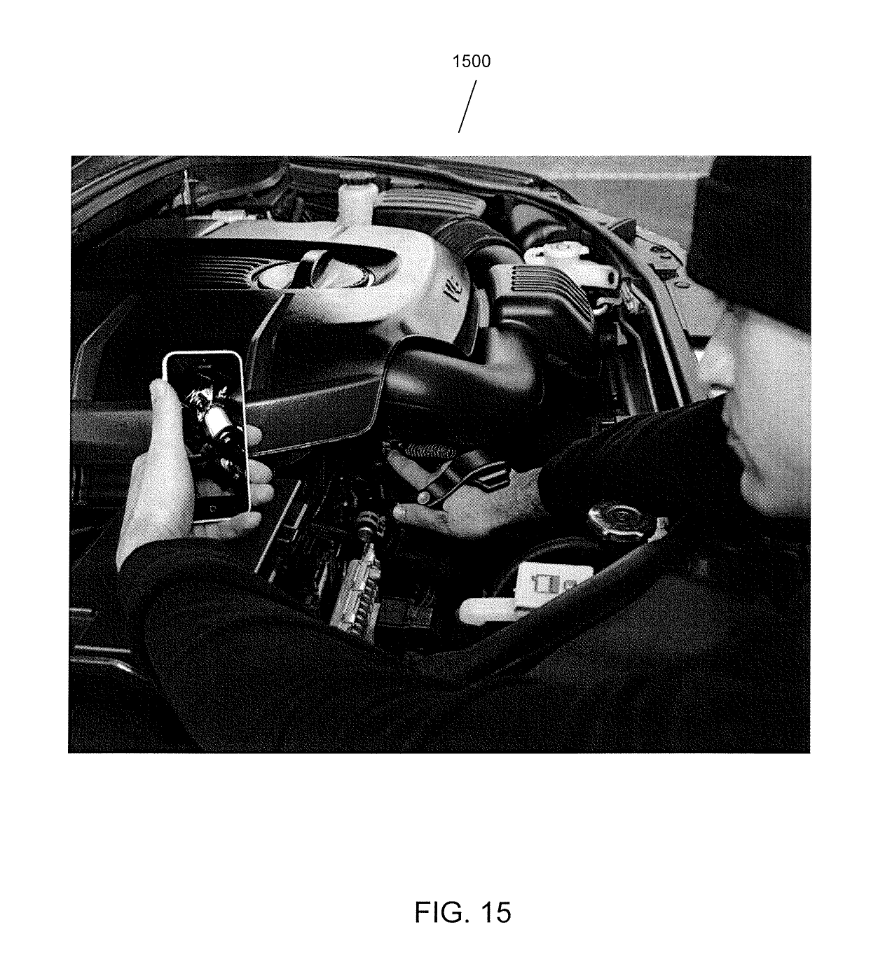

FIG. 15 shows an example 1500 in which the external camera/smartphone combination is used by a mechanic to view a hard to reach place inside a vehicle's engine.

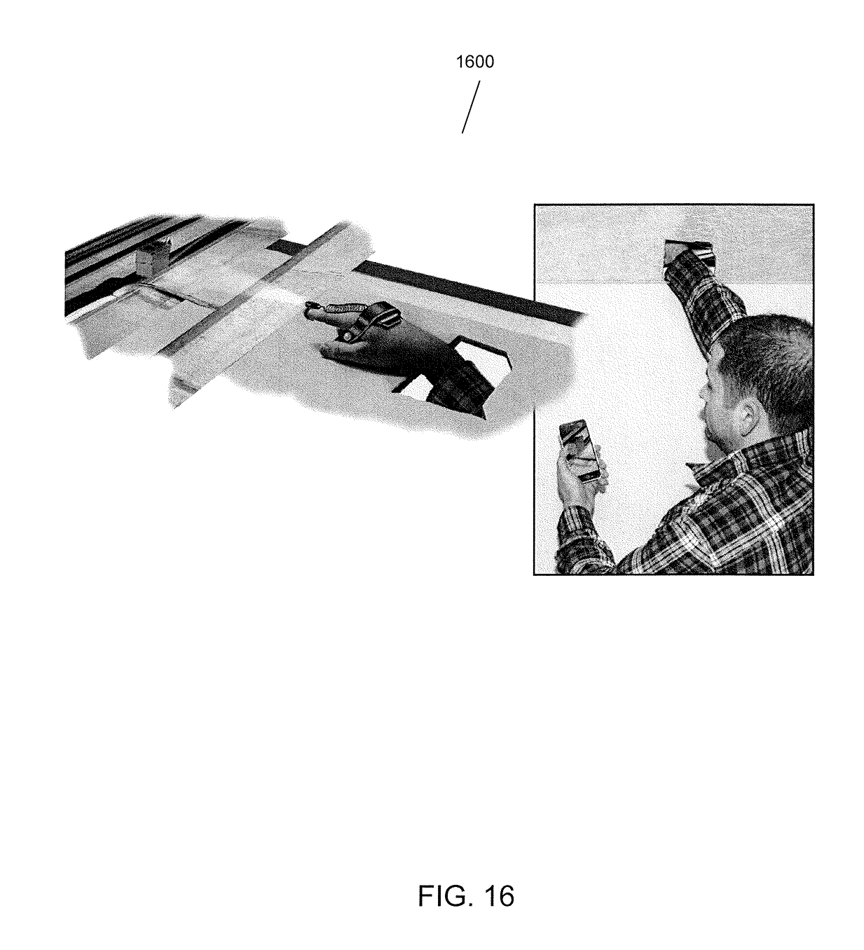

FIG. 16 shows an example 1600 in which the external camera/smartphone combination is used to view a hard to reach place above a room's ceiling.

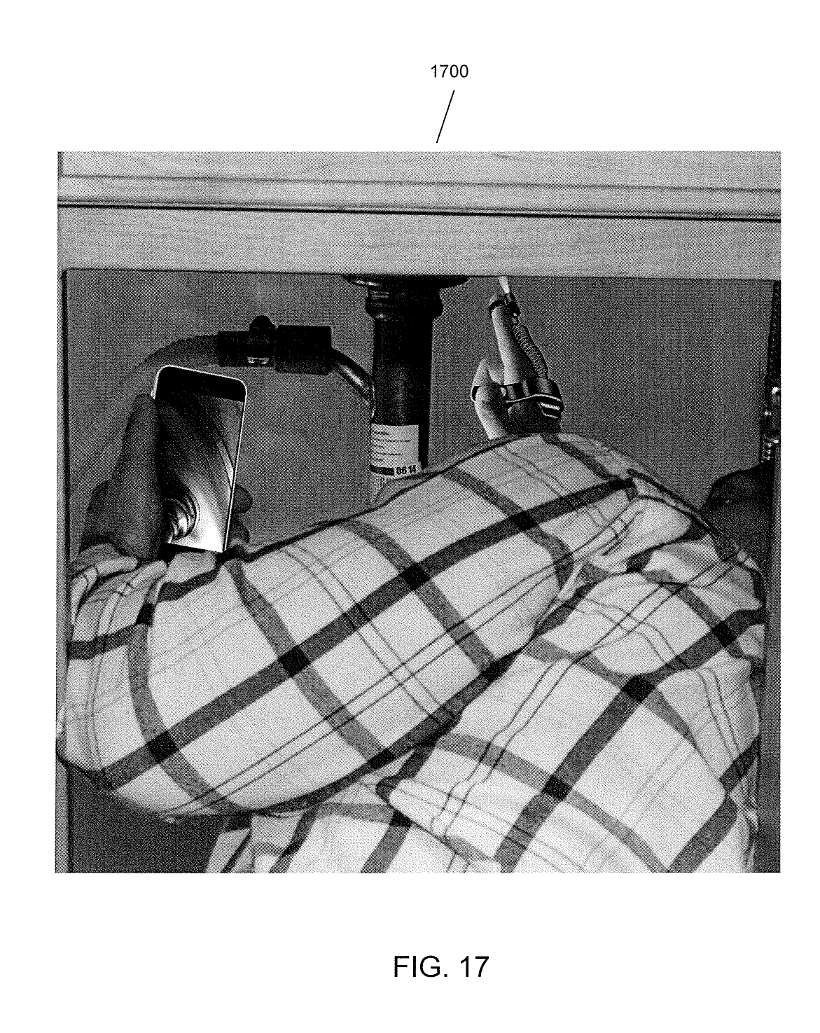

FIG. 17 shows an example 1700 in which a plumber uses the external camera/smartphone combination to view a hard to reach place under a sink.

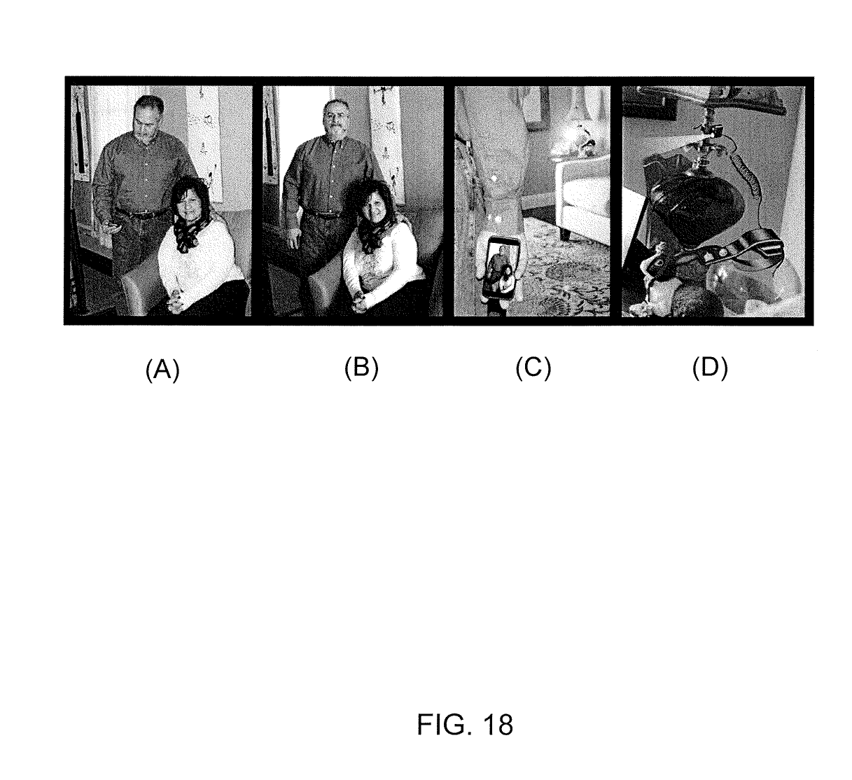

FIG. 18 shows a selfie application using the external camera/smartphone combination. In this case, in (A), a user uses the app on his smartphone to instruct the external camera, in (D), to take his photo (B). In (C), the user may view the image captured by the external camera on his smartphone.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

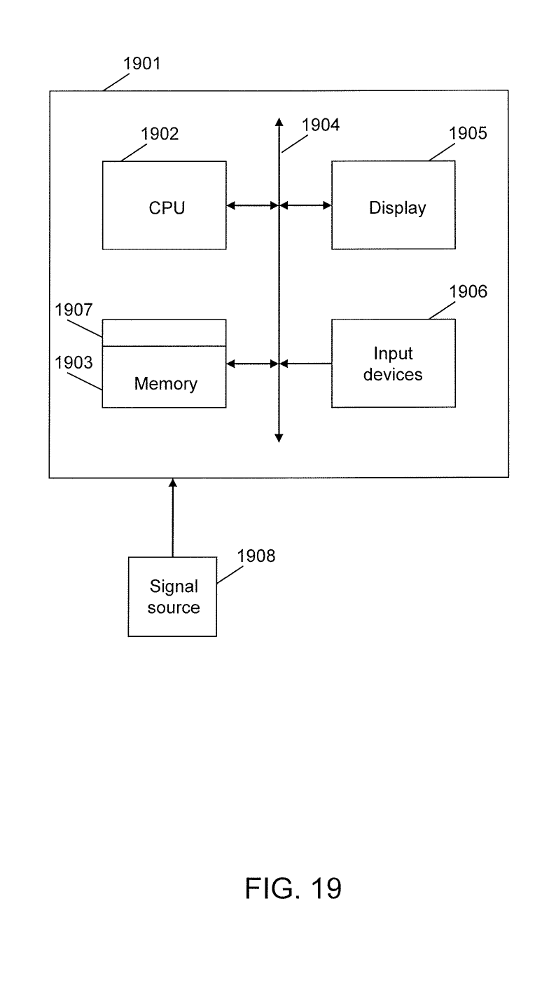

Referring now to FIG. 19, according to an exemplary embodiment of the present invention, a computer system 1901 can comprise, inter alia, a central processing unit (CPU) 1902, a memory 1903 and an input/output (I/O) interface 1904. The computer system 1901 is generally coupled through the I/O interface 1904 to a display 1905 and various input devices 1906 such as a mouse and keyboard. The support circuits can include circuits such as cache, power supplies, clock circuits, and a communications bus. The memory 1903 can include RAM, ROM, disk drive, tape drive, etc., or a combination thereof Exemplary embodiments of present invention may be implemented as a routine 1907 stored in memory 1903 (e.g., a non-transitory computer-readable storage medium) and executed by the CPU 1902 to process the signal from the signal source 1908. As such, the computer system 1901 is a general-purpose computer system that becomes a specific purpose computer system when executing the routine 1907 of the present invention.

The computer platform 1901 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An external camera for a portable electronic device, comprising:
a first portion configured to connect to a person's finger, the first portion including a camera and a first terminal;
a second portion configured to connect to a person's hand, the second portion including a second terminal for connecting with the first terminal of the first portion, and a first switch and a second switch for controlling the camera; and
a wire connected between the first terminal of the first portion and the second terminal of the second portion.

2. The external camera of claim 1, wherein the second portion includes a radio frequency (RF) module, wherein image data captured by the camera is provided to the RF module via the wire.

3. The external camera of claim 2, wherein the RF module transmits the image data to a portable electronic device.

4. The external camera of claim 3, wherein the portable electronic device includes a smartphone or a tablet.

5. The external camera of claim 2, wherein the RF module includes a WiFi module.

6. The external camera of claim 1, wherein the first switch controls a zoom feature of the camera.

7. The external camera of claim 1, wherein the second switch controls a shutter feature of the camera.

8. A system including an external camera and a portable electronic device, comprising:
a portable electronic device; and
an external camera, the external camera including:
a camera and light module, the camera and light module including a strap for connecting the camera and light module to a person's finger; and
a control module, the control module including a strap for connecting the control module to a person's hand away from the person's finger,
wherein the camera and light module is configured to obtain image data and provide the image data to the control module via a databus,
wherein the control module is configured to control the camera and light module in obtaining the image data and wirelessly provide the image data to the portable electronic device in near real-time streaming format.

9. The system of claim 8, wherein the image data is provided from the control module to the portable electronic device via a WiFi link.

10. The system of claim 8, wherein the image data is viewed on a display of the portable electronic device.

11. The system of claim 8, wherein the portable electronic device includes a software application enabling the portable electronic device to display the image data received from the external camera.

12. The system of claim 8, wherein a zoom ratio of the external camera is greater than that of a built-in camera of the portable electronic device.

13. The system of claim 8, wherein the portable electronic device includes a smartphone or a tablet.

14. The system of claim 8, wherein the control module includes buttons or switches to control a zoom feature of the camera and lighting module.

15. A method of operating an external camera for a smartphone, comprising:
activating the external camera, the external camera including:
a first portion configured to connect to a person's finger, the first portion including a camera; and
a second portion configured to connect to a person's hand, the second portion including at least one switch for controlling the camera;
activating a software application on the smartphone, wherein in response to the activation of the software application a wireless link is established between the external camera and the smartphone;
streaming live video from the external camera to the smartphone via the wireless link;
displaying the live video on a the smartphone; and
controlling the external camera based on the live video displayed on the smartphone.

16. The method of claim 15, wherein controlling the external camera includes moving the external camera, zooming in or out with the external camera, or capturing a still image with the external camera.
